(19) United States
(12) Patent Application Publication
(10) Pub. No.: US 2012/0052910 A1
(43) Pub. Date: Mar. 1, 2012

(54) AUDIO PORT COMMUNICATION AND POWER DEVICE

(75) Inventors: Guo Qiang Mu, Diamond Bar, CA (US); Zheng Zhou, Anaheim, CA (US); Ge Jiang, Orange, CA (US); Curtis Terry Conant, San Pedro, CA (US); Arleta Monica Caridas, Yorba Linda, CA (US)

(73) Assignee: ID TECH, CYPRESS, CA (US)

(21) Appl. No.: 12/871,822

(22) Filed: Aug. 30, 2010

(51) Int. Cl. H04B 1/38

(52) U.S. Cl. 455/558

(57) ABSTRACT

Versions of the present invention have many advantages, including providing communication devices that can transact on a universal peripheral device with a host device that may have different serial interface connectors, proprietary communication protocols or mechanical shapes. Among the many other advantages include that the peripheral device does not need a power source aside from the power supplied to it by the host device.

One embodiment is a communication device comprising a host device comprised of software and an audio connector input; a peripheral device comprised of an analog and digital processor, a card reader and an audio connector output; and an audio connector line connecting said audio connector output and said audio connector input.

### BACKGROUND

(1) Field of the Invention

The field of the invention is communication devices for peripherals.

(2) Description of Related Art including Information Disclosed under 37 CFR 1.97 and 1.98

Salespersons that travel, merchants with mobile operations, merchants with limited sales volumes, consumers and others have a need to electronically process charge cards without paying the high cost of a point of sale terminal With the rapid adoption of smart phones such as the iPhone, BlackBerry, and Google Android, there is a strong desire to connect the phone to peripherals such as credit card readers which will allow the traveling salesperson, small merchant, consumers and others to remotely electronically enter and process credit transactions. However, every phone has a different serial interface connector and a proprietary communication protocol. One has to develop a solution for each phone.

The cost and time to “keep up” thus becomes almost prohibitive. Finding a way to overcome these two challenges will greatly increase the utilization of host devices such as smart phones.

Additional information relevant to attempts to address these problems can be found in U.S. Pat. Nos. 4,672,661, 6,830,182 B2, 7,757,945, and Des. 339,807, as well as U.S. Patent Publication Nos. 2009/0072033 A1, 2009/0127336 A1, 2009/0009356 A1, 2010/0163618 A1, 2010/0198728 A1, 2010/0161433 A1 and 2010/0182764 A1. However, each one of these references may suffer at least from one or more of the following disadvantages: peripheral devices not universally applicable for different host devices, not being powered only by the host device, inapplicable for card readers, not being as robust for different uses and unnecessary complexity.

All referenced patents, applications and literatures are incorporated herein by reference in their entirety. Furthermore, where a definition or use of a term in a reference, which is incorporated by reference herein is inconsistent or contrary to the definition of that term provided herein, the definition of that term provided herein applies and the definition of that term in the reference does not apply. The invention may seek to satisfy one or more of the above-mentioned desires. Although the present invention may obviate one or more of the above-mentioned desires, it should be understood that some aspects of the invention might not necessarily obviate them.

### BRIEF SUMMARY OF THE INVENTION

Accordingly, an object of the present invention is for communication devices that can transact on a universal peripheral device with host devices that may have different serial interface connectors, proprietary communication protocols or mechanical interfaces.

One embodiment is a communication device comprising a host device comprised of software and an audio connector input; a peripheral device comprised of an analog and digital processor, a card reader and an audio connector output; and an audio connector line connecting the audio connector output and the audio connector input.

The communication device may have an audio connector line comprising a first channel for power from the host device to the peripheral device; a second channel for host device data from the host device to the peripheral device; and a third channel for peripheral device data from the peripheral device to the host device. The analog and digital processor may comprise a power processing circuit; a data processing circuit; and means for analog to digital data conversion. The data processing circuit may feature the ability to perform at least one of: encrypting the peripheral device data; creating a key for the peripheral device; and managing a key for the peripheral device. The peripheral device may receive the host device data and power from the audio connector output and transfer the peripheral device data to the audio connector input. The host device may transfer the host device data and power from the audio connector output and receive the peripheral device data from the audio connector input. The software may perform at least one of transforming the peripheral device data from analog to digital; transforming the host device data from digital to analog; generating an analog signal for power; processing the peripheral device data; and sending the peripheral device data. The peripheral device may further comprise means for analog to digital data conversion; and means for digital to analog data conversion.

An embodiment of the present invention is a method of communication comprising the steps of providing a host device comprised of software and an audio connector input; providing a peripheral device comprised of an analog and digital processor, a card reader and an audio connector output; and communicating between the host device and the peripheral device via an audio connector line connecting the audio connector output and the audio connector input.

The audio connector line may comprise of a first channel for power from the host device to the peripheral device; a second channel for host device data from the host device to the peripheral device; and a third channel for peripheral device data from the peripheral device to the host device. The analog and digital processor may comprise a power processing circuit; a data processing circuit; and means for analog to digital data conversion. The data processing circuit may feature the ability to perform at least one of: encrypting the peripheral device data; creating a key for the peripheral device; and managing a key for the peripheral device. The peripheral device may receive the host device data and power from the audio connector output and transfer the peripheral device data to the audio connector input. The host device may transfer the host device data and power from the audio connector output and receive the peripheral device data from the audio connector input. The software may perform at least one of transforming the peripheral device data from analog to digital; transforming the host device data from digital to analog; generating an analog signal for power; processing the peripheral device data; and sending the peripheral device data. The peripheral device may further comprise means for analog to digital data conversion; and means for digital to analog data conversion.

An embodiment is a communication device comprising a host device; a peripheral device; an audio connector line facilitating communication between said host device and said peripheral device; and means for immovably attaching a peripheral device to a host device.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 illustrates an exemplary embodiment of an audio connector line as an audio jack.

FIG. 2A illustrates an exemplary embodiment of a peripheral device not connected to a host device via an audio connector line.

FIG. 2B illustrates an exemplary embodiment of a peripheral device connected to a host device via an audio connector line.

FIG. 3 illustrates an exemplary embodiment of the individual parts and interactions between a peripheral device and a host device.

FIG. 4 illustrates an exemplary embodiment highlighting some features of a data processing circuit.

### REFERENCE NUMERALS IN DRAWINGS

The table below lists the reference numerals employed in the figures, and identifies the element or structure designated by each numeral. It should be understood that throughout the drawings, corresponding reference numerals indicate like or corresponding parts and features
98 Audio connector prong 1
100 Audio connector prong 2
102 Audio connector prong 3
104 Audio connector prong 4
106 Audio connector line
108 Peripheral device
110 Host device
112 Peripheral device data
114 Card reader
116 Analog and digital processor
118 Data processing
120 Audio output
122 Audio input
124 Software
126 Host device data
128 Power
130 Power processing circuit
132 Analog to digital conversion
134 Digital to analog converter
136 Analog to digital converter
138 Data processing
140 Send data
142 Analog to digital converter
144 Encryption
146 Key generation
148 Key management
150 Clip

### DETAILED DESCRIPTION OF THE INVENTION

The invention and its various embodiments can now be better understood by turning to the following detailed description of the preferred embodiments, which are presented as embodiments of the invention defined in the claims. It is expressly understood that the invention as defined by the claims may be broader than the embodiments described below.

One object of the present invention is to provide a universal peripheral device compatible with a variety of host devices with different serial interface connectors, different proprietary communication protocols and different mechanical interfaces. Embodiments of the invention provide for a variety of approaches that may encompass electrical, mechanical, usability, firmware, software, power management, bi-directional communication, and data security aspects to address this object.

Embodiments may provide an electrical solution that uses an audio jack, a universal device on many host devices such as mobile phones or computers. There may also be a standard digital UART interface to work with the analog audio interface. Optionally, a circuit may be used to harness power from ordinary audio waveforms.

Embodiments may also have major firmware design features. Firmware may utilize standard digital UART interfaces to work with the analog audio interface to minimize the required electronics. This makes it possible for the device to be powered with very limited power. This may limit the number of data bits that have the same value, thereby minimizing the data error rate on the phone, and simplifies the design. Firmware may also convert data from the device to an audio waveform recognizable by the software on the phone. Firmware may also extract commands from the phone embedded in an audio waveform. An additional function of firmware may be for power management such as turning off any part that is not being actively used to minimize power consumption.

Embodiments may have software features. A standard digital UART interface may be utilized to work with the analog audio interface. This may limit the number of data bits that have the same value and therefore minimize the data error rate on the device and simplifying the electrical design. Software may dynamically generating audio waveforms that serve as commands from the phone to the device, thus enabling bi-directional communication between the two. Software may also dynamically generate an audio waveform that is utilized to power the device, automatically recognize a connected device or turn off the device when not in use.

Embodiments may have power management as a collective system involving electrical, firmware, and software. Features may include of harnessing power from an ordinary audio waveform. Features may include an efficient electrical design using very low power. Other features may include an electrical circuit that converts audio waveform to DC power, electrical and firmware design that allows for turning off any unused part or software design that dynamically generates audio waveforms for creation of power when necessary.

Embodiments may also feature bi-directional communications. As an example, The invention may support data communication from the device to the phone, as well as command communication from the phone to the device. This may provide advantages in feedback, control, settings, and authentication purposes.

Embodiments may also feature data security. For example, data from the device may be secured with strong encryption algorithms such as 3DES and AES-128, AES-192, and AES-256. Also, key management schemes such as DUKPT may be supported. With DUKPT, no two device share the same encryption key, and no two transaction on the same device share the same encryption key. Encryption may be processed in a dedicated hardware for faster speed and better security. Also, a peripheral device and a host device, such as a phone, can mutually authenticate each other, minimizing fraud.

Embodiments may feature plug-n-play with mobile devices and other devices that have audio jacks. For example, no external power may be required as power may be supplied through the right audio channel of the phone jack. The left audio channel of a host device, such as a mobile device, may send parameter setting commands to a peripheral device for security purposes. Features may also include a special secured “Double Bits” code that goes through a microphone into host devices, such as mobile devices. For example, TriMag III ASIC may provide Bi-directional card reading capability and can read up to 3 tracks of magnetic encoded information.

### DETAILED DESCRIPTION OF THE ELEMENTS

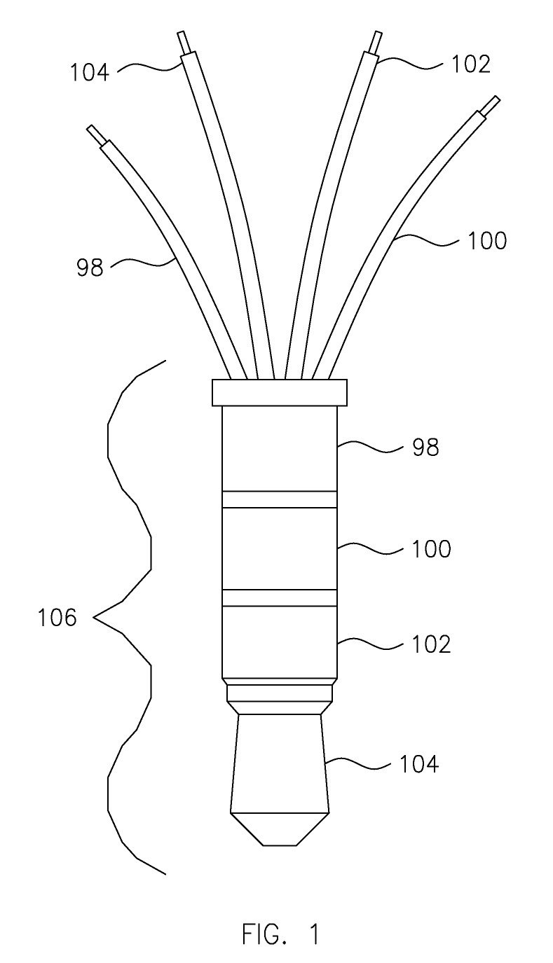

FIG. 1 illustrates an audio jack. In certain embodiments, an audio connector line 106 is an audio jack. The different prongs, 98, 100, 102, or 104 may typically correspond to any of a ground, left, right, and a microphone channel for audio communication. In embodiments of the present invention, three prongs of an audio jack may correspond to any of a channel for power, communication from host to peripheral or communication from peripheral to host. It is not important whether any of channel 98, 100, 102 or 104 is used for either a channel for power, communication from host to peripheral or communication from peripheral to host so long as three functions are present. In an exemplary embodiment, 100 may correspond to power, 102 may correspond to communication from host to peripheral and 104 may correspond to communication from peripheral to host. In this way, bilateral communication between host and peripheral is ensured as well as power from the host device to the peripheral device.

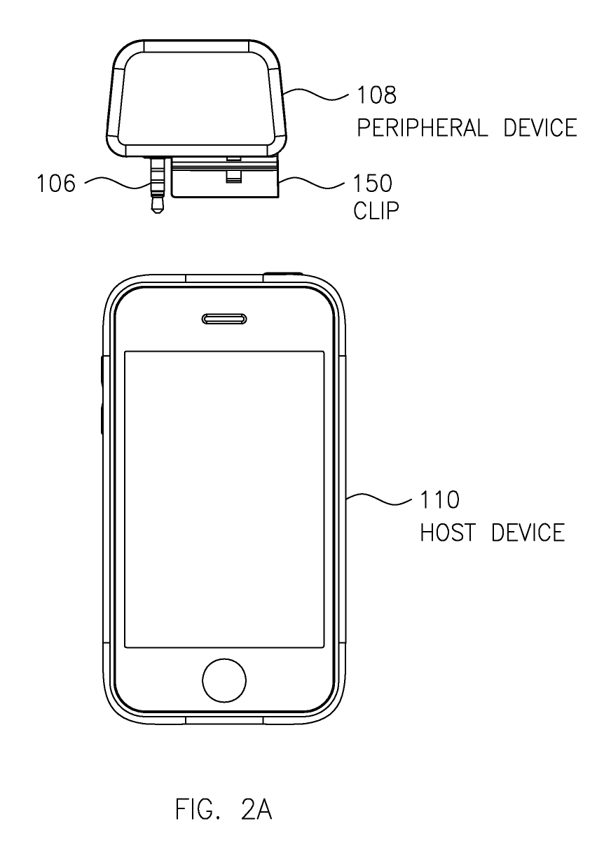

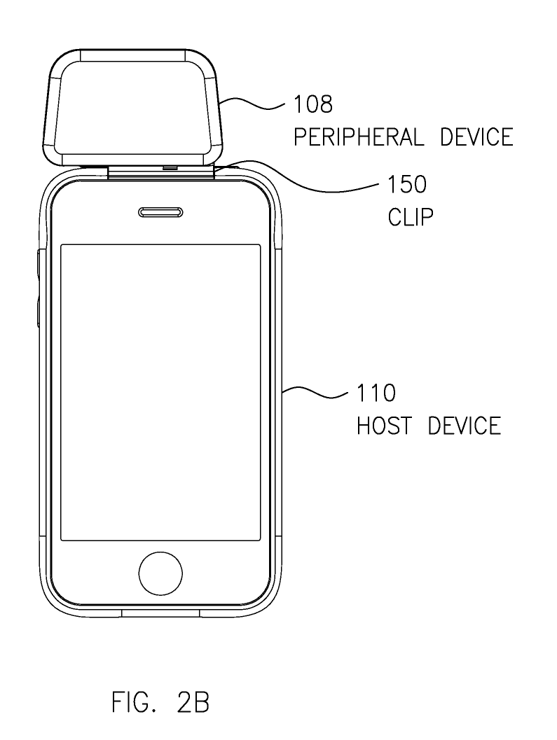

FIG. 2A and FIG. 2B illustrates an embodiment in which an audio connector line 106, here a universal audio jack, connects between a peripheral device 108, here a card reader, and a host device 110, here a mobile phone.

FIG. 2A illustrates an embodiment where a peripheral device 108 is not yet interfaced with a host device 110 as the audio connector line 106 is not connecting the peripheral device 108 with the host device 110.

FIG. 2B illustrates an embodiment where a peripheral device 108 is interfaced with a host device 110 as the audio connector line 106 interfaces with the host device 110 and facilitates communication between the peripheral device 108 and the host device 110. Also, a clip 150 allows for the peripheral device 108 to be anchored and immovably attached to the host device 110 as to facilitate easier usage of the peripheral device 108. In certain embodiments, the clip 150 and peripheral device combination may be removed from a host device 110 and modified for usage with other host devices.

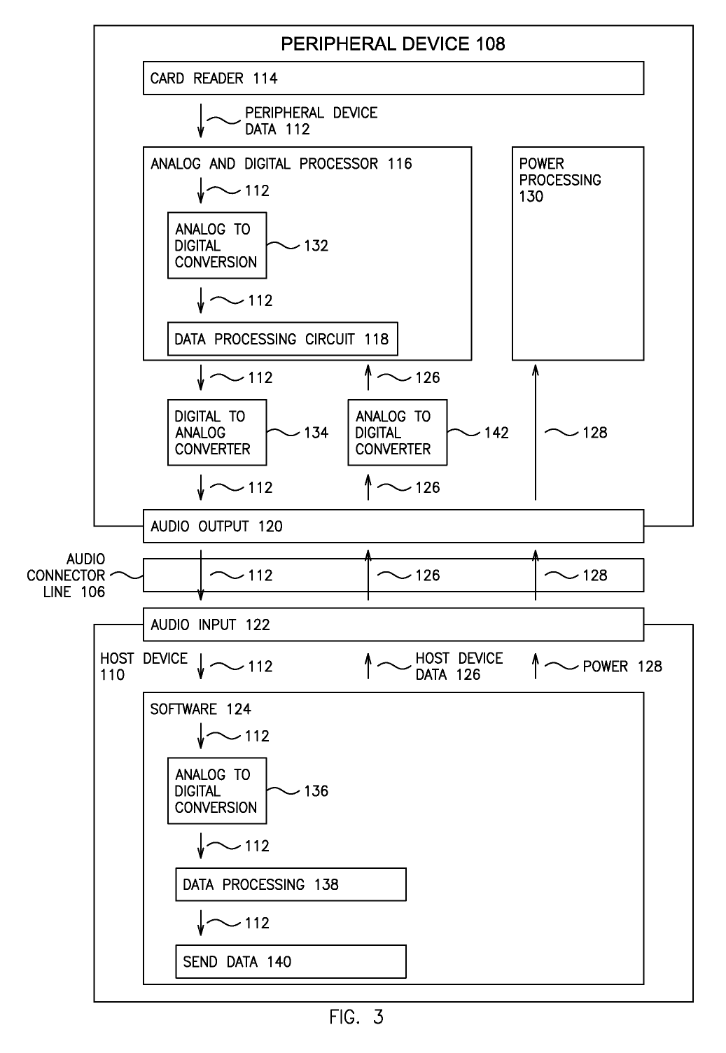

FIG. 3 illustrates a graphical representation of an embodiment where there are interactions between the peripheral device 108 and the host device 110. In this embodiment, peripheral device data 112 begins on the peripheral device 108 in a card reader 114. Peripheral device data 112 begins as analog data from the card reader 114 before it is transferred to the analog and digital processor 116. The analog and digital processor 116 converts the analog peripheral device data 112 from analog to digital 132 data. Once the information is digitized, the analog and digital processor 116 processes the peripheral device data 112 by data processing 118. Data processing 118 performs at least one of creating a key for the data 146, managing a key for the data 148 and encrypting the data 144. The analog and digital processor 116 then receives the data 112 from the data processing circuit 118 and transfers it to a digital to analog converter 134. The digital to analog converter 134 transfers the peripheral device data 112 in analog form to the audio output 120. The audio output 120 on the peripheral device 108 transfers the data to the audio input 122 on the host device 110 via the audio connector line 106. The software 124 on the host device 110 then receives the peripheral device data 112 from the audio input 122 and transforms the peripheral device data 112 from analog to digital 136, processes the data 138 and sends the data 140. In an exemplary embodiment, the host device is a cellular phone and will send the processed peripheral device data 112 out via the wireless connection. Any means for converting digital signals to analog signals or means for converting analog signals to digital may be accomplished by at least a circuit or software that does so.

Host device data 126, which may consist of data and commands, is transferred from the software 124 on host device 110 out the audio input 122 via the audio connector line 106 to the audio output 120 converted from analog to digital data 142 and finally to the analog and digital processor 116. The host device data may be converted from digital to analog data on the software 124. In optional embodiments, the analog and digital processor 116 may transfer the host device data to the card reader 114. In exemplary embodiments, the host device data 126 may originate from somewhere on the host device 110. Host device data 126 received by the analog and digital processor 116 may be converted from analog to digital information on the processor 116 and may undergo further data processing 118.

Power 128 may also be transferred from the software 124 on the host device to the audio input 122 and then via the audio connector line 106 to the audio output 120 and finally to a power processing circuit 130. In optional embodiments, power 128 may be generated or processed from elsewhere on the host device 110 to the audio input 122 and then via the audio connector line 106 to the audio output 120 and finally to a power processing circuit 130. The power processing circuit may power the entire peripheral device 108 directly or power certain parts of the peripheral device directly, such as the analog and digital processor 116 or the card reader 114 or the converters 134, 142.

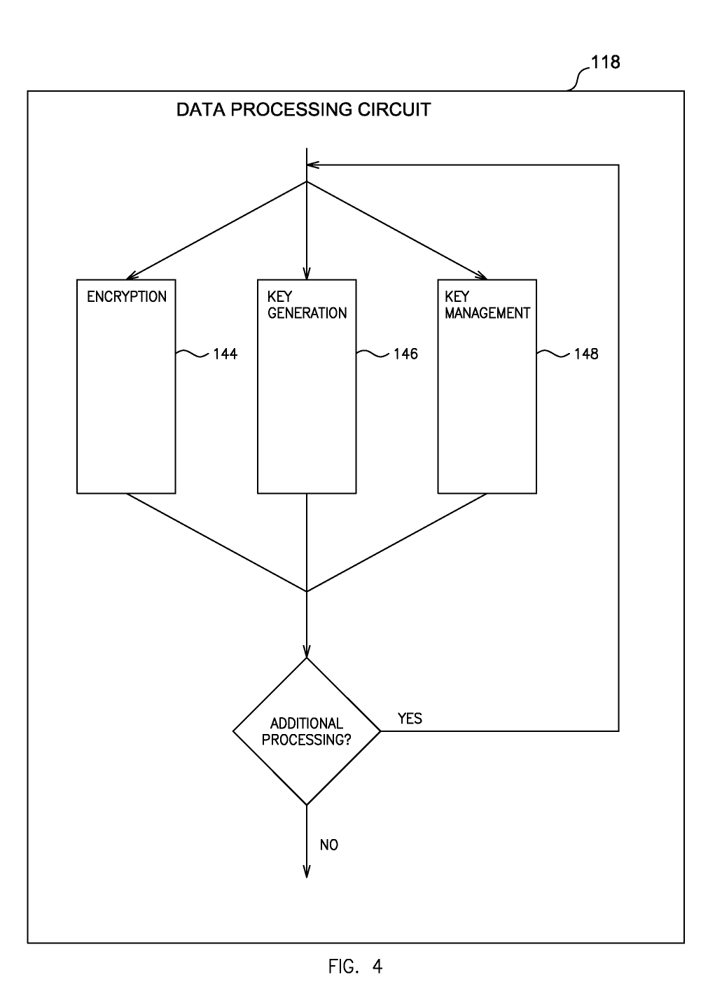

FIG. 4 illustrates a graphical representation of an embodiment with a data processing circuit 118. The data processing circuit features the ability to perform at least one of encryption 144, key generation 146 and key management 148. Key generation 146 and key creation 146 are the same. In some embodiments, only one of these functions is performed. In other exemplary embodiments, iterations of these features may be performed such as encryption as well as key generation and key management or only encryption and key management. For example in one embodiment, encryption 144 is performed and additional processing is needed. Thereby, key generation 146 is performed but additional processing is needed. Thereby, key management 148 is also performed. If further processing is needed, further encryption 144 may be performed as well. Thereby, encryption, key generation, key management and further encryption are performed in this exemplary embodiment.

### How the Invention Is Used

Among the many uses for the many embodiments of the present invention is as a card reader, such as a credit card reader. In one embodiment, the peripheral device may be a credit card reader and the host device may be a smart phone. The user may attach and interface the credit card reader to the smart phone via the audio connector line, which may be a phone jack, attached at the respective communication ports of the credit card reader and smart phone. Thereby as an exemplary embodiment, the user may pay for a transaction set up on the smart phone via credit card by simply swiping the credit card reader.

### ADVANTAGES OF THE INVENTION

The described versions of the present invention have many advantages, including providing communication devices that can transact on a universal peripheral device with a host device that may have different serial interface connectors, proprietary communication protocols or mechanical shapes. Among the many advantages include that the peripheral device does not need a power source aside from the power supplied to it by the host device.

As an example of one of many advantages, embodiments of the present invention are not limited by the types of host devices used. For instance, the host device could be different types of portable electronics such as an iphone or a laptop or may even be a desktop computer. However, all of them could use the same peripheral device if they employ the system in an embodiment of the present invention. For example, all of the possible different host devices, such as a smart phone, PDA, laptop or desktop computer can interface with the same peripheral device, such as a credit card reader through an audio jack interface in an embodiment of the invention.

Furthermore, the invention does not require that all the advantageous features and all the advantages need to be incorporated into every embodiment of the invention. Also, this partial list of advantages is not an exhaustive list or description of all of the advantages from the embodiments and versions of the present invention.

### Closing

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed herein even when not initially claimed in such combinations. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Thus, specific embodiments and applications of the present invention have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the invention. In addition, where the specification and claims refer to at least one of something selected from the group consisting of A, B, C . . . and N, the text should be interpreted as requiring only one element from the group, not A plus N, or B plus N, etc.

What is claimed is:

1. A communication device comprising:
a) a host device comprised of software and an audio connector input;
b) a peripheral device comprised of an analog and digital processor, a card reader and an audio connector output; and
c) an audio connector line connecting said audio connector output and said audio connector input.

2. The communication device of claim 1, wherein said audio connector line comprises:
a) a first channel for power from said host device to said peripheral device;
b) a second channel for host device data from said host device to said peripheral device; and
c) a third channel for peripheral device data from said peripheral device to said host device.

3. The communication device of claim 2, wherein said analog and digital processor comprises:
a) a power processing circuit;
b) a data processing circuit; and
c) means for analog to digital data conversion.

4. The communication device of claim 3, wherein said data processing circuit features the ability to perform at least one of:
a) encrypting said peripheral device data;
b) creating a key for said peripheral device; and
c) managing a key for said peripheral device.

5. The communication device of claim 4, wherein said peripheral device receives said host device data and power from said audio connector output and transfers said peripheral device data to said audio connector input.

6. The communication device of claim 5, wherein said host device transfers said host device data and power from said audio connector output and receives said peripheral device data from said audio connector input.

7. The communication device of claim 6, wherein said software performs at least one of:
a) transforming said peripheral device data from analog to digital;
b) transforming said host device data from digital to analog;
c) generating an analog signal for power;
d) processing said peripheral device data; and
e) sending said peripheral device data;

8. The communication device of claim 7, wherein said peripheral device comprises:
a) means for analog to digital data conversion; and
b) means for digital to analog data conversion.

9. A method of communication comprising the steps of:
a) providing a host device comprised of software and an audio connector input;
b) providing a peripheral device comprised of an analog and digital processor, a card reader and an audio connector output; and
c) communicating between said host device and said peripheral device via an audio connector line connecting said audio connector output and said audio connector input.

10. The method of claim 9, wherein said audio connector line comprises:
a) a first channel for power from said host device to said peripheral device;
b) a second channel for host device data from said host device to said peripheral device; and
c) a third channel for peripheral device data from said peripheral device to said host device.

11. The method of claim 10, wherein said analog and digital processor comprises:
a) a power processing circuit;
b) a data processing circuit; and
c) means for analog to digital data conversion.

12. The method of claim 11, wherein said data processing circuit features the ability to perform at least one of:
a) encrypting said peripheral device data;
b) creating a key for said peripheral device; and
c) managing a key for said peripheral device.

13. The method of claim 12, wherein said peripheral device receives said host device data and power from said audio connector output and transfers said peripheral device data to said audio connector input.

14. The method of claim 13, wherein said host device transfers said host device data and power from said audio connector output and receives said peripheral device data from said audio connector input.

15. The method of claim 14, wherein said software performs at least one of:
a) transforming said peripheral device data from analog to digital;
b) transforming said host device data from digital to analog;
c) generating an analog signal for power;
d) processing said peripheral device data; and
e) sending said peripheral device data;

16. The communication device of claim 15, wherein said peripheral device comprises:
a) means for analog to digital data conversion; and
b) means for digital to analog data conversion.

17. A communication device comprising:
a) a host device;
b) a peripheral device;
c) an audio connector line facilitating communication between said host device and said peripheral device; and
d) means for immovably attaching a peripheral device to a host device.
